(19) United States
(12) Patent Application Publication
(10) Pub. No.: US 2008/0076094 A1
(43) Pub. Date: Mar. 27, 2008

(54) System And Method For Facilitating Adjustment Of An Oral Appliance

(76) Inventor: Jeffrey Hindin, Suffern, NY (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/860,728

(22) Filed: Sep. 25, 2007

Related U.S. Application Data
(60) Provisional application No. 60/847,766, filed on Sep. 27, 2006.

(51) Int. Cl. A61C 19/06

(52) U.S. Cl. 433/215; 433/229

(57) ABSTRACT

A system and method for facilitating adjustment of an oral appliance. Various sensors are attached to a patient so as to measure physiological parameters such as heart rate variability, skin temperature, skin resistance and conductance, etc. These parameters are analyzed while an oral appliance is inserted into a patient. The appliance may be adjusted so as to produce beneficial modifications of these parameters.

This application claims priority to provisional application 60/847,766 entitled “SYSTEM AND METHOD FOR FACILITATING ADJUSTMENT OF AN ORAL APPLIANCE” filed Sep. 27, 2006, the entirety of which is hereby incorporated by reference.

### BACKGROUND OF THE INVENTION

Dental appliances are known to have physiological effects on a patient. For many years dentists have designed and inserted oral appliances or orthotics to treat bruxism, pain in the head and neck, and related jaw pain. Such appliances are used to correct dysfunctions due to jaw position, vertical dimension, and hyper contraction of muscles. Appliances may also help treat snoring and sleep apnea. When these oral appliances are designed, fitted and adjusted properly, patients often have demonstrated improvement of oro-facial symptoms, and reported improvement in a wide range of systemic symptoms and disorders.

In order to ensure proper placement, prior art techniques rely on time consuming diagnostic films or subjective feedback from the patient. The patient may articulate to the dentist that the appliance is uncomfortable and/or causing pain and the dentist adjusts the appliance accordingly. As shown basically in FIG. 1, in a prior art system 50, when a dentist 52 seeks to fit an appliance 54 in a patient 56, the primary source of feedback 58 dentist 52 receives is generated from patient 56. Clearly, use of such feedback 58 is problematic in that not all patients will react to an improper fit, patients may react in different ways, and patients may not appreciate a minor variation in a fit and thus see no reason to communicate an issue to the dentist.

Moreover, treatment results are individual and not necessarily predictable or consistent from practitioner to practitioner. The number of visits required to adjust an oral appliance varies and dentists frequently spend many more hours than anticipated adjusting the appliance. Often the only evidence used to show results of adjustment techniques has been based on patient subjective findings and is anecdotal as to what is occurring both locally and systemically.

A small portion of the dental community has used biofeedback or other physiological monitoring for stress and anxiety measurement in the treatment of bruxism. These biofeedback devices often use an EMG (Electromyogram) and a sound device to alert the patient that he was “clenching” or “grinding” his teeth. Skin conductance and skin temperatures have been used to evaluate patient responses to dental smells or other items in the dental armamentarium that elicit anxiety or stress reactions. More recently, heart rate variability (“HRV”) was used to evaluate dental patients prior to undergoing dental surgery. Patients with lower heart rate variability had more negative outcomes. Heart rate variability has also been used in the evaluation of oral appliances for sleep apnea where increased HRV was shown to correlate with less or no apnea events. However, HRV has not been used in conjunction with adjusting an oral appliance.

There appears to be some prior art publications that discuss monitoring of physiological parameters to assist a dentist in various applications. Other prior art systems use biofeedback to ameliorate symptoms in other parts of the body. For example, U.S. patent publication 20030033730 appears to disclose using biofeedback in the context of strengthening a foot in conjunction with the use of footwear. However, the prior art appears to be completely devoid of a system showing the use of monitoring physiological parameters to adjust an oral appliance or to aid in the selection of an oral appliance.

### SUMMARY OF THE INVENTION

One embodiment of the invention is a method for adjusting an oral appliance comprising inserting an oral appliance into a mouth of a patient and monitoring at least one physiological parameter of the patient, wherein the physiological parameter includes at least one of: heart rate variability, EKG, skin temperature, skin conductance, heart beats per minute, EMG, oxygen saturation, end tidal CO2, and respiration rate. The method further comprises adjusting the oral appliance based on the monitored physiological parameter.

Another embodiment of the invention is a system for facilitating adjustment of an oral appliance, the system comprising an oral appliance and at least one sensor effective to monitor at least one physiological parameter of a patient, wherein the physiological parameter includes at least one of: heart rate variability, EKG, skin temperature, skin conductance, heart beats per minute, EMG, oxygen saturation, end tidal CO2, and respiration rate. In the system, the oral appliance is effective to be adjusted based on the monitored physiological parameter.

### BRIEF DESCRIPTION OF THE DRAWINGS

FIG. 1 a system diagram of a system for inserting an oral appliance into a patient in accordance with the prior art.

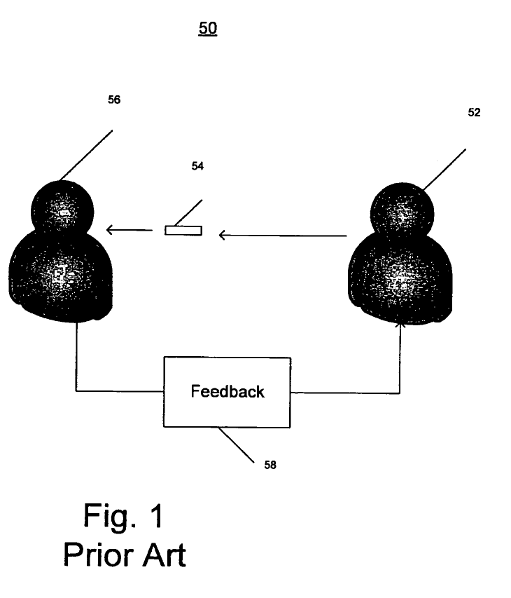

FIG. 2 is system diagram of a system for adjusting an oral appliance in a patient in accordance with an embodiment of the invention.

FIG. 3 is a flow diagram illustrating a process for adjusting an oral appliance in a patient in accordance with an embodiment of the invention.

FIG. 4 is a screen shot of physiological parameters of a patient which may be monitored in accordance with an embodiment of the invention.

FIG. 5 is a screen shot of physiological parameters of a patient which may be monitored in accordance with an embodiment of the invention.

### DETAILED DESCRIPTION OF THE PREFERRED EMBODIMENT(S)

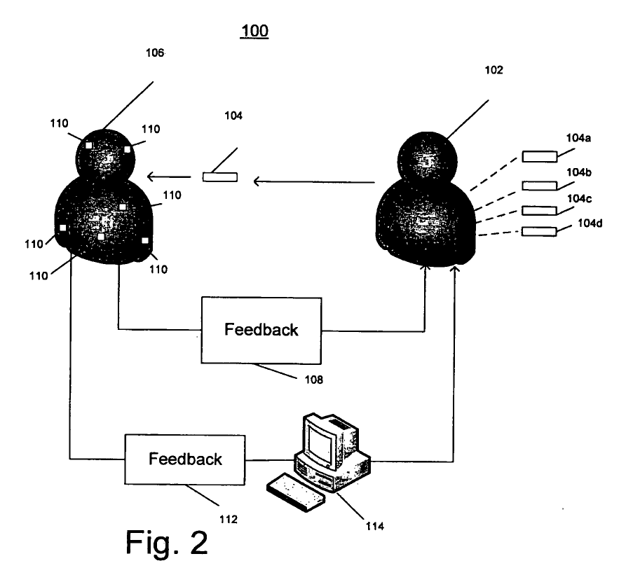

Referring to FIG. 2, there is shown a system for facilitating adjustment of an oral appliance in accordance with embodiment of the invention. As shown in system 100, a dentist 102 may place an oral appliance 104 in a patient 106. As in the prior art, feedback 108 from patient 106 may be used to facilitate insertion of oral appliance 104. Additionally, sensors 110 may be placed at various locations on patient 106. Sensors 110 are used to detect certain physiological parameters experienced by patient 106. Sensors 110 generate additional feedback 112 which may be converted into a readable display on a monitor 114 that, in turn, may be viewed and interpreted by dentist 102. Dentist 102 may then adjust appliance 104 as discussed below.

Sensors 110 may be used to monitor key indicators during the insertion and adjustment of a dental appliance. For example, sensors 110 may be used to monitor EKG, Respiration, EMG, Temperature, Skin Conductance and other parameters, to provide more objective measures to dentist 102 so as to complement the subjective reporting of patients. Sensors 110 may be wired to monitor 114 or may communicate wirelessly and convert each relevant physiological parameter into a signal that can be read and displayed by monitor 114.

In accordance with an embodiment of the invention, through the use of sensors 110 a plurality of physiological parameters of a patient may be continually monitored while an oral appliance is adjusted. For example, by measuring parameters such as radiographic films, an MRI, patient forms (identifying medical history, history of a present illness, and pain questionnaires), clinical exam, study models (stone models fabricated from an impression), heart rate, heart rate variability, skin temperature, respiration, etc., a dentist can more accurately and more appropriately adjust a dental appliance. Furthermore, the dentist may design, fit, adjust, evaluate, etc. the dental appliance so as to ensure its proper fit. The dentist may also chose to adjust the appliance by selecting another appliance as shown at 104a, 104b, 104c and 104d. An oral appliance in accordance with the invention includes dentures, partial dentures, fixed prosthodontics (crowns and bridges which are permanently cemented), orthodontics and oral orthotic/appliance/splints and other dental restorations. Adjustment of the oral appliance may include design of an oral appliance, ensuring proper fit, adjustment, selection and evaluation. It may also include selection among a plurality of available oral appliances.

In operation, a dental assistant may attach sensors 110 to patient 106 and record a pre-insertion and post-insertion baseline that shows changes as a result of appliance 104. Feedback data 112 provides treatment results that show general indicators consistent from dental practitioner to practitioner. Feedback data 112 may also be correlated with other measures used in dentistry such as radiography. Experimentation has shown a clear correlation between the objective feedback data 112 being collected and the subjective feedback 108 responses of patients. Use of feedback 112 means that adjustment and balance of an oral appliance can be significantly improved, and the number of visits required to do the adjustments can be reduced.

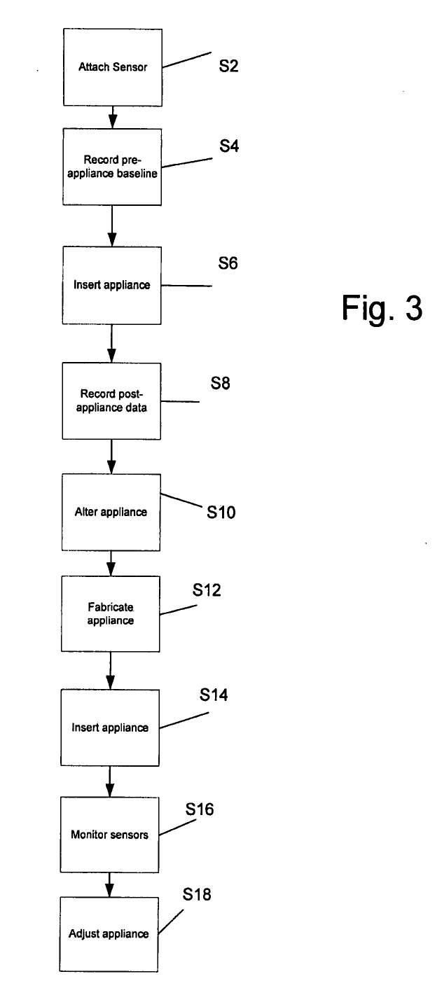

Referring to FIG. 3, there is shown a process which can be performed in accordance with the embodiment of the invention. The process could be implemented using, for example, system 100 described with reference to FIG. 2. As shown in FIG. 3, at a step S2, at least one sensor may be attached to a patient. At step S4, a base-line is generated of physiological data prior to insertion of an oral appliance. At step S6, a dental appliance, such as a wax bite, may be inserted into the patient. At step S8, physiological data from the sensors are monitored. At step S10, the appliance is adjusted so that the position of the patient's bite corresponds with a desirable change in at least one of the criteria measured by the sensors including, for example, EMG, heart rate variability, respiration rate, skin temperature, skin conductance, etc. At step S12, a lab then may fabricate the appliance, and return it to the dentist. Thereafter, once the appliance has been obtained, it is inserted at Step S14 and a protocol may be used by the dentist including a five-minute habituation, five-minute pre-insertion, and five-minute post insertion, while observing any physiological data from the sensors at Step S16. If desired, the dentist may make further adjustments to the appliance at Step S18 in response to the data received at Step S16.

Habituation is the opposite of arousal. A patient generally ceases to respond or reduces his response to a constant stimulus. For example, after 15 trials of listening to a moderate intensity tone, heart rate might no longer increase in response to the tone. Predictable, low-intensity stimuli that convey no new information and require no new response readily produce habituation. Habituation is inhibited when a stimulus is intense, complex, and unique and the patient desires to respond to it. In use, the dentist may attach all relevant leads to the patient and let the patient sit or “habituate” for 5 minutes. Data recorded during this period may be discarded. During this time, movement by the patient should be inhibited.

Some parameters which may be monitored include heart rate by EKG or BVP (e.g. a plythysmograph measuring blood volume pulse through a finger sensor), respiration rate via belt or cannula SEMG (surface electromyography) including measurement of muscle action potentials or electrical record of muscle activity including muscle tension and related pain measurement; skin temperature; skin conductance; oxygen saturation, end tidal CO2 and heart rate viability (“HRV”). Many of these sensors are available from THOUGHT TECHNOLOGY.

Sensors 110 may be used to monitor many physiological parameters. For example, sensors 110 may also include a respiration sensor. A respiration sensor is sensitive to being stretched. When strapped around a client's abdomen or chest, the sensor will convert the expansion and contraction of the rib cage or abdominal area to a rise and fall in a signal on a screen. Respiration sensors may be wrapped around a patient's chest and at the level of the navel. There is generally no typical waveform but there is typically a fast rise that slows near the top of the breath followed by a fast fall that slows near the end of the breath. The pattern may change as the patient focuses on a task, talks or falls asleep. In an acute stress response, a patient may tense their chest, neck and throat muscles leading to restricted lungs and then faster, erratic breathing. Similarly, in chronic postural problems, chronic tension in the chest, back neck and shoulders is enough to cause pain and reduce the diaphrag's ability to contract. Breathing is then shifted to the intercostals and cervical muscles and is shallow and rapid. An oral appliance may be adjusted to minimize fast, erratic breathing.

Sensors 110 may include an EKG sensor such as the EKG Pro/Flex. The signal output by this sensor may be enhanced by using an extender cable and UNI-GEL electrodes. The sensor detects and amplifies the small electrical voltage that is generated by the heart muscle when it contracts. A dentist may then look at changes in heart rate, heart rate variability, and spectral analysis of an EKG.

Sensors 110 may include a skin temperature sensor. Skin temperature is detected using a thermistor which is a transducer that converts temperature and peripheral blood flow into a resistance value. Increases in skin temperature have been shown to relate to autonomic nervous system function. In these type of sensors, resistance drops with rising temperature. A lead can be placed on the patient's hand to detect this temperature. An oral appliance may be adjusted so as to increase a patient's temperature. Sensors 110 may include a SEMG sensor.

SEMG includes measurement of muscle action potentials or an electrical record of muscle activity including muscle tension and related pain measurement. This sensor may be used to measure the relevant frequency produced by surface electrical potential over muscle groups. A raw SEMG shows a frequency spectrum that includes various frequencies of waves which occur when a muscle unit contracts, and it may show the power of the contraction as a vertical deflection. For example, SEMG sensors may indicate that there is too much activity on one side of the patient's face in comparison to the contra-lateral side, and an oral appliance should be adjusted accordingly.

Sensors for skin conductance measure changes in conductance or resistance to current flow across the skin's surface. The parameters may depend on how much a person is sweating. Such changes in sweating may be a good indicator of autonomic responses to stress, of arousal and of other changes in sympathetic activity. The skin conductance may be measured by imposing a current across the skin using two or three surface electrodes. An oral appliance may be adjusted so as to decrease and maintain skin conductance.

An EKG sensor provides data which, through an algorithm, may be used to monitor heart rate viability (“HRV”). Heart rate variability is the spontaneous change in heart rate. It is related to the interaction between sympathetic and parasympathetic influences at the sinoatrial node in the heart. Heart rate variability interacts with respiratory and blood pressure regulation. It also refers to the beat-to-beat alterations in the heart rate. The EKG of healthy individuals exhibits periodic variation in R-R intervals. This variation is sometimes called respiratory sinus arrhythmia (“RSA”). RSA fluctuates with the phase of respiration—e.g. cardio-acceleration during inspiration and cardio-deceleration during expiration. RSA is predominantly mediated by respiratory gating of the parasympathetic efferent activity in the heart. Vagal efferent traffic to the sinus node occurs primarily in phase with expiation and is absent or attenuated during inspiration.

HRV is used as a marker of reduced vagal activity and as a marker of both dynamic (responsive to acute stressors) and cumulative (wear and tear over time) stress. HRV appears to mark two processes: 1) frequent activation—short term dips in HRV in response to acute “stress” and 2) inadequate response—long term vagal withdrawal resulting in overactivity of the sympathetic control of cardiac rhythm.

Heart rate oscillations may be measured at various frequency ranges. Anxiety or rumination may increase activity in the very low frequency range (0.005-0.05 Hz). Relaxation and paced, slow breathing will increase activity in the low frequency range (0.05-0.15 Hz). Faster breathing may increase activity in the high frequency range (0.15-0.4 Hz). Some factors which affect HRV: aging decreases vagal tone and reduces beta-adrenergic responsiveness; exercise increases HRV; with “stress”, HRV decreases with SNS arousal.

Low HRV is also a strong predictor of sudden cardiac death. It is a marker of fatal ventricular arrhythmia. It may also show probability of survival even without history of congestive heart disease. An oral appliance may be adjusted so as to increase HRV.

It is desirable to have many or all of the referenced physiological parameters displayed on monitor 114 so that a dentist may quickly analyze the parameters and adjust an appliance so as to produce beneficial modifications of these parameters.

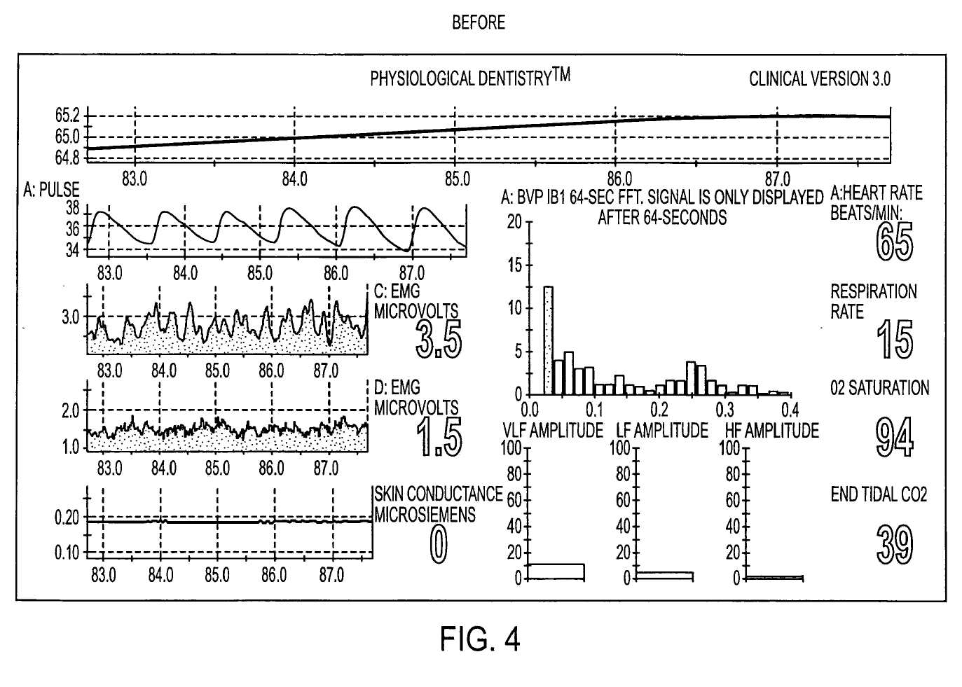

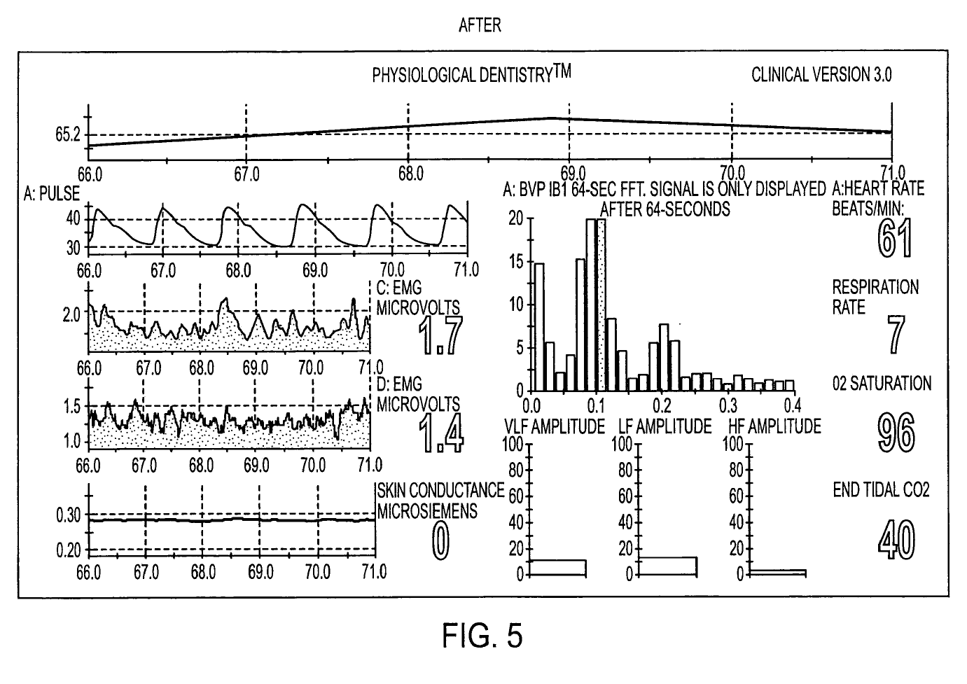

Some examples of screens which may be used by a dentist are shown at FIGS. 4 and 5. FIG. 4 is labeled “Before” as it shows a patient's physiological parameters before an inserted oral appliance is adjusted. FIG. 5 is labeled “After” as it shows a patient's parameters after an oral appliance has been adjusted. As can be discerned, by review of the parameters in FIG. 4 and adjusting the oral appliance, the patient's heart rate and respiration rate are lower, and the patient's O2 saturation and end tidal CO2 are higher. By monitoring these parameters, a dentist can adjust an oral appliance more effectively. For example, the oral appliance may be adjusted so that the respiration rate may be decreased without a decrease in oxygen saturation or an increase in heart rate.

Through experimentation it has been found that the benefits of the above described physiological measuring can be applied to other aspects of dentistry. These areas include restorative dentistry, crown and bridge placement, and partial and full dentures. Patients can also be routinely assessed before and after insertion of oral appliances.

When using a system in accordance with the invention, dentists may routinely monitor their patient's physiological functions and assess the risks and benefits of their treatment. In addition, dentists may design treatment specifically aimed to promote and enhance physiological function as well as biofeedback programs where appropriate. Moreover, a system in accordance with the invention may be used as a common ground where physicians, dentists, biofeedback practitioners and researchers can communicate and coordinate treatment to provide better health care for the public.

The use of the oral appliance may, in turn, affect certain physiological parameters. For example, the oral appliance can be used specifically to affect heart rate variability. Furthermore, some of the embodiments of the invention could be used in any dental treatment, not simply to adjust a dental appliance. For example, any treatment that changes the jaw position or affects the vertical height of the mouth can be monitored by looking at the physiological parameters discussed above as anything that changes the jaw position or modifies the vertical height of the mouth may affect certain physiological parameters. This includes, for example, crowns and orthodontures. Routine dental procedures may affect a patient and a system in accordance with the invention may be used to monitor those effects.

Thus, by monitoring physiological parameters experienced by a patient, an oral appliance may be adjusted more effectively than systems available in the prior art.

While preferred embodiments of the invention have been disclosed, the invention is not so limited and the scope of the invention is only limited by the scope of the claims.

What is claimed is:

1. A method for adjusting an oral appliance comprising:
inserting an oral appliance into a mouth of a patient;
monitoring at least one physiological parameter of the patient, wherein the physiological parameter includes at least one of: heart rate variability, EKG, skin temperature, skin conductance, heart beats per minute, EMG, oxygen saturation, end tidal CO2, and respiration rate; and
adjusting the oral appliance based on the monitored physiological parameter.

2. The method as recited in claim 1, wherein the oral appliance is adjusted so as to increase skin temperature of the patient.

3. The method as recited in claim 1, wherein the oral appliance is adjusted so as to decrease the respiration rate of the patient.

4. The method as recited in claim 3, wherein the respiration rate includes a balance between thoracic and abdominal respiration.

5. The method as recited in claim 3, wherein the oral appliance is adjusted so as to avoid a decrease in oxygen saturation and to avoid an increase in heart rate.

6. The method as recited in claim 1, wherein the oral appliance is adjusted so as to decrease imbalances in SEMG.

7. The method as recited in claim 1, wherein the oral appliance is adjusted so as to increase heart rate variability.

8. The method as recited in claim 1, wherein the adjusting includes fabricating the oral appliance.

9. The method as recited in claim 1, wherein the adjusting includes selecting another oral appliance.

10. The method as recited in claim 1, wherein the physiological parameter includes all of heart rate variability, EKG, skin temperature, skin conductance, heart beats per minute, EMG, oxygen saturation, end tidal CO2, and respiration rate.

11. A system for facilitating adjustment of an oral appliance, the system comprising:
an oral appliance; and
at least one sensor effective to monitor at least one physiological parameter of a patient, wherein the physiological parameter includes at least one of: heart rate variability, EKG, skin temperature, skin conductance, heart beats per minute, EMG, oxygen saturation, end tidal CO2, and respiration rate;
wherein the oral appliance is effective to be adjusted based on the monitored physiological parameter.

12. The system as recited in claim 11, wherein the oral appliance is effective to be adjusted so as to increase skin temperature of the patient.

13. The system as recited in claim 11, wherein the oral appliance is effective to be adjusted so as to decrease the respiration rate of the patient.

14. The method as recited in claim 13, wherein the respiration rate includes a balance between thoracic and abdominal respiration.

15. The method as recited in claim 13, wherein the oral appliance is adjusted so as to avoid a decrease in oxygen saturation and to avoid an increase in heart rate.

16. The system as recited in claim 11, wherein the oral appliance is effective to be adjusted so as to decrease imbalances in SEMG.

17. The system as recited in claim 11, wherein the oral appliance is effective to be adjusted so as to increase heart rate variability.

18. The system as recited in claim 11, wherein the adjusting includes fabricating the oral appliance.

19. The system as recited in claim 11, wherein the adjusting includes selecting another oral appliance.

20. The system as recited in claim 11, wherein the physiological parameter includes all of heart rate variability, EKG, skin temperature, skin conductance, heart beats per minute, EMG, oxygen saturation, end tidal CO2, and respiration rate.
